(19) United States
(12) Patent Application Publication
(10) Pub. No.: US 2016/0197765 A1
(43) Pub. Date: Jul. 7, 2016

(54) FORWARDED LOG LINES

(71) Applicant: HEWLETT PACKARD ENTERPRISE DEVELOPMENT LP, Houston, TX (US)

(72) Inventors: Andrew Brown, Houston, TX (US); Hakeem Ali Ibrahim Mohamed, Houston, TX (US)

(21) Appl. No.: 14/916,122

(22) PCT Filed: Sep. 27, 2013
(86) PCT No.: PCT/US2013/062352

§ 371 Date: Mar. 2, 2016

(51) Int. Cl. H04L 12/24; H04L 29/12

(52) U.S. Cl. CPC H04L 41/069; H04L 61/1582

(57) ABSTRACT

Techniques for aggregating log lines are provided. In one aspect, a log aggregation node is identified. A connection to the log aggregation node may be established. Log lines may be sent to the log aggregation node over the established connection. The log aggregation node may forward the log lines to a log server.

### BACKGROUND

Modern data centers may contain tens or hundreds of thousands of computers, which can also be referred to as nodes. Each node may contain a port, such as a serial port, through which log data may be sent. Log data is typically information related to the node that may be analyzed to determine node performance or to debug errors that may have occurred on the node. In many data centers, the log data from each node may be collected on a small number of logging servers. Thus, log data from many nodes may be retrieved without having to access each node individually.

### BRIEF DESCRIPTION OF THE DRAWINGS

FIG. 1 depicts an example system that may utilize the log aggregation techniques described herein.

FIG. 2 depicts another example of a system that may utilize the log aggregation techniques described herein.

FIG. 3 is an example of a high level flow diagram for forwarding log lines to a log aggregation node, according to the techniques described herein.

FIG. 4 is an example of a high level flow diagram for identifying a log aggregation node and forwarding log lines to the identified node according to techniques described herein.

FIG. 5 is an example of a high level flow diagram for receiving log lines from nodes and appending node identifiers prior to forwarding, in accordance with techniques described herein.

FIG. 6 is another example of a high level flow diagram for forwarding log lines to a node that aggregates log lines from other log aggregation nodes, according to techniques described herein.

FIG. 7 is an example of processor instructions for receiving log lines from nodes and forwarding to a log server according to techniques described herein.

FIG. 8 is an example of processor instructions for identifying a log aggregation node as well as forwarding to a log server according to techniques described herein.

### DETAILED DESCRIPTION

Although providing central log servers to aggregate log data from many nodes provides an efficient way of gathering log data without having to access each node individually, such aggregation is not without problems. For example, log data is typically sent out of a serial port on a node. In order for a log server to gather log data from each node, a serial cable must be routed between each node and the log server. Given the ever increasing density of nodes in a standard rack, the burden of such cabling becomes overwhelming. For example, there are current data center cartridge architectures that allow for 45 cartridges with four nodes per cartridge per enclosure, with 10 enclosures per rack. This density translates to 1800 nodes per rack, which in turn would necessitate 1800 serial cables. As it would be unreasonable to have 1800 serial ports on a log server, additional equipment, such as serial expanders would be needed.

To partially overcome this problem, the virtual serial port was created. Using a virtual serial port, log data that would normally have been sent over the serial port is sent over a network connection. For example, each node may establish a connection with a log server over a network. For example, the network may be an Ethernet network that connects all of the nodes and log servers within a data center. Log data that would normally be output over a serial port may be placed into a packet and sent over the connection established with the log server. Because the data is traveling over a network, the data connection may be encrypted to enhance security. As should be understood, use of a network topology eliminates the need to have a specific cable between each node and the log server.

Although use of a virtual serial port resolves some of the issue related to gathering log data at a log server, the virtual serial port itself creates additional problems. For example, because a connection must be established between each node and the log server, each node must be individually configured with the network address of the log server. In addition, a connection must be established and maintained between each node and the log server. Although this may not be a large issue at the node, the same cannot be said about the log server. Given the example density above, a single rack may need 1800 connections to be established with the log server. Further exacerbating the problem may be the use of encryption on each connection. If encryption is used, the overhead for encrypting and decrypting the log information sent over the connection may be excessive.

The techniques described herein overcome these problems by aggregating log data prior to sending to a log server. Each node may send log data over a virtual serial connection to an aggregation node. The aggregation node may be local to the enclosure and/or rack, in a trusted domain, such that encryption is not needed between the node and the aggregation node. The aggregation node may establish a secure connection, such as a Secure Shell (SSH) connection with the log server. The log data received from each node by the aggregation node may be sent to the log server. Thus, there is no longer a need for each node to establish a secure connection to the log server.

In order to overcome the problem of configuring each node with the aggregation node, a self discovery mechanism may be used. In one example implementation, each node may listen for a broadcast message from a aggregation node. Once the broadcast message is received, the node may retrieve the address of the aggregation node from the message. In an alternate example implementation, each node may broadcast a request message asking for the network address of an aggregation node. An aggregation node may respond, and the node may store the address of the aggregation node. In either case, the address of the aggregation node need not be preconfigured into each node.

Because all log data is being sent to a single log server, it may be desirable to be able to identify the data sent from each node. Log data from a node is typically a line of text, which may be referred to as a log line. In some example implementations, an identifier is appended to each log line, such that the particular node that generated the log line can be identified. The identifier may be a unique attribute, such as an IP address or a node name. The particular form of the identifier is relatively unimportant, so long as it is understood to uniquely identify one node in the data center. In some example implementations, the node identifier may be appended to each log line by the node sending the log line, while in other example implementations, the node identifier may be appended by the aggregation node. These techniques are described in further detail below and in conjunction with the appended figures.

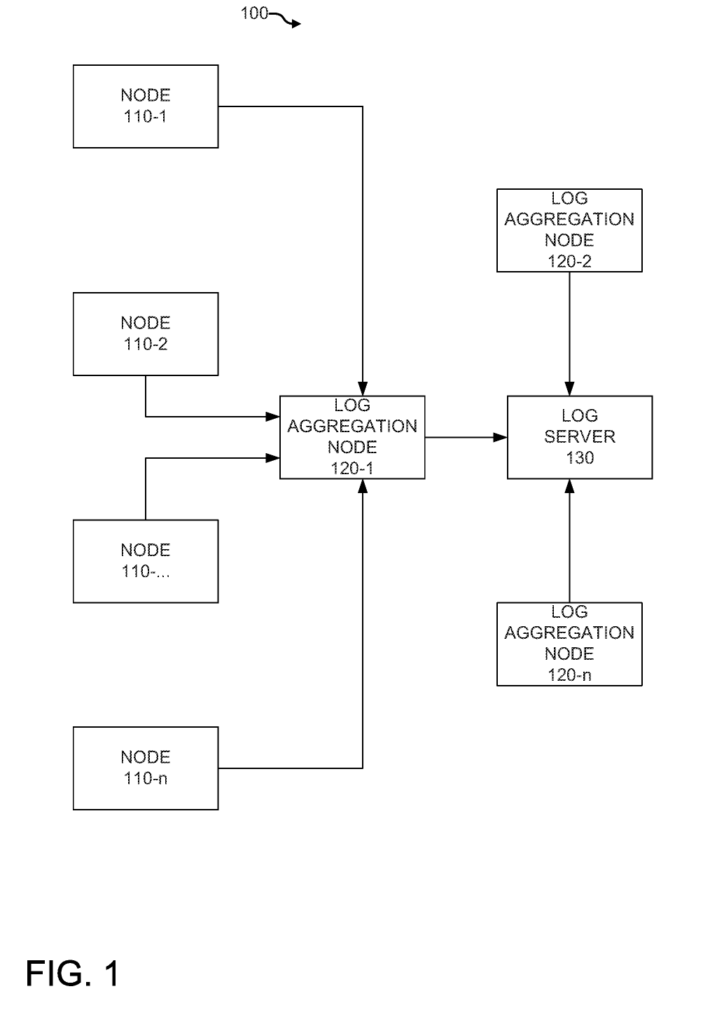

FIG. 1 depicts an example system that may utilize the log aggregation techniques described herein. System 100 may include nodes 110-1 . . . n, log aggregation nodes 120-1 . . . n, and log server 130. Nodes 110-1 . . . n may be nodes such as server computer nodes. Nodes 110-1 . . . n may also be other types of nodes, such as switch nodes, I/O nodes, or any other type of node. What should be understood is that nodes 110-1 . . . n are nodes that may have data that is to be output to a log file. For purposes of this disclosure, data that is to be output to a log file may be referred to as a log line. This is not to imply that the data that output is a single line of data. Rather, a log line is simply a unit that may refer to an item that the node wishes to write to a log file.

Log aggregation node 120-1 may be a node that aggregates log lines from the nodes 110-1 . . . n. In some example implementations, log aggregation node 120-1 may be a node that performs tasks that are disjoint from the workloads performed by the nodes 110-1 . . . n. In other example implementations, log aggregation node 120-1 may perform the same tasks as nodes 110-1 . . . n, but performs the log aggregation tasks in addition. For example, a rack may contain multiple nodes. In some example implementations, one node may be selected to perform the log aggregation function, in addition to processing normal workloads. In other example implementations, the log aggregation node may be responsible for log aggregation, but is not responsible for processing general workloads.

It should be noted that there may be a plurality of log aggregation nodes. As shown in FIG. 1, there may be log aggregation nodes 120-2 . . . n. Each of these nodes may perform a similar function as log aggregation node 120-1. For simplicity of explanation, one log aggregation node 120-1 is described in detail. However, it should be understood that there may be many log aggregation nodes. System 100 may also include log server 130. Log server 130 may be a server computer which collects log lines from all of the nodes 110-1 . . . n (through the log aggregation nodes). In other words, when a system administrator desires to review the logs of the various nodes, the log lines may be retrieved from the log server 130. Although not shown, the nodes, log aggregations nodes, and log server may all be communicatively coupled via a network or networks. Thus, each element described may be able to communicate with at least a subset of the other elements described,

In operation, each node 110-1 . . . n may first identify its associated log aggregation node. In one example implementation, each node may broadcast a message to all elements on the network, requesting identification of the log aggregation server. The log aggregation server that is to be associated with the node sending the request may then respond, indicating that it is the log aggregation server to be used by the requesting node. In other example implementations, each log aggregation server may broadcast a message to all other elements indicating that it has log aggregation capabilities. Nodes that receive the broadcast message may then choose to use the broadcasting node as the log aggregation node.

Regardless of implementation, each node determines the address of the log aggregation server that is to handle the log line aggregation function for the node. The node may then store the address of the log line aggregation server. The node may then establish a connection with the log aggregation node. Typically, the log aggregation node and the nodes may all be within the same trust domain, such that a simple, insecure connection may be established. However, the techniques described herein are equally applicable if a secure connection is established between the node and the log aggregation node.

When a node wishes to send a log line to the log server, the node sends the log line to the log aggregation node over the established connection to the log aggregation node. In some example implementations, the node appends a node identifier on the log line. For example, the node identifier may be an address of the node generating the log line. As another example, the node identifier may be a node name. In other example implementations, the node identifier is appended by the log aggregation node. The purpose of the node identifier is to determine the node that generated the log line, as will be explained below.

The log aggregation node may establish a secure connection with the log server. The log aggregation node and the log server may not be in the same trust domain, and as such it may be prudent to use a secure connection. Once the log line has been received by the log aggregation node, and the node identifier has been appended (either by the node or by the log aggregation node), the log aggregation node may forward the log line to the log server. In some example implementations, the log aggregation node may forward log lines upon receipt, while in other example implementations the log aggregation node may buffer log lines and send them to the log server once the buffer is full. Regardless of implementation, what should be understood is that each node need not create a connection, much less a secure connection, with the log server. As such, the processing load on the log server is reduced.

Upon receipt of a log line forwarded form a log aggregation node, the log server may simply append the received log line to a log file (not shown). In some example implementations, the log server may maintain a separate file for each log aggregation node, while in other example implementations, the log server may maintain a single file for log lines from all log aggregation nodes. When a system user wishes to analyze log lines from a single node, the appropriate log file may be retrieved from the log server. The file may then be filtered based on the node identifier of interest, the node identifier having been appended to the log lines as described above. As such, the log lines form an individual node may then be retrieved and analyzed.

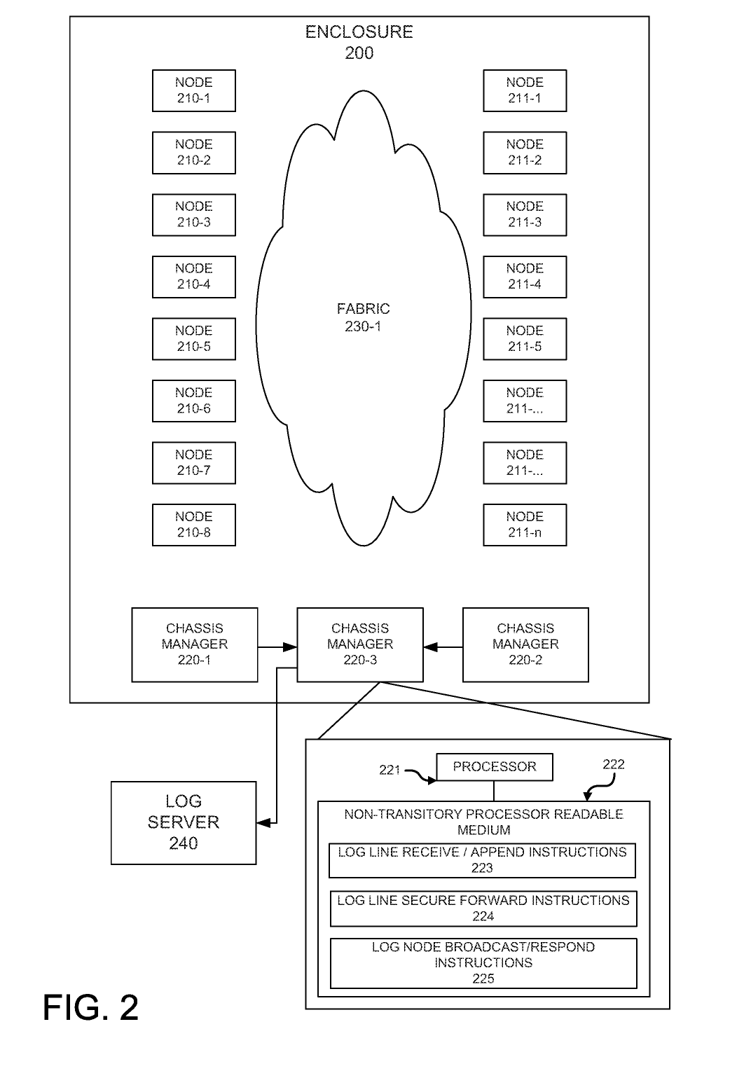

FIG. 2 depicts another example of a system that may utilize the log aggregation techniques described herein. Enclosure 200 may be an enclosure that supports many nodes. For example, enclosure 200 may be an architecture that supports nodes that are included on cartridges (not shown). For example, enclosure 200 may contain a plurality of slots. For example, enclosure 200 may contain 45 slots, each of which may contain a cartridge. In an example implementation, each cartridge may contain up to four nodes, such as server nodes. The enclosure may provide support systems for the cartridges, such as by providing power and cooling. The enclosure may also provide a communications fabric that allows elements within the enclosure to communicate.

Thus the enclosure may support a plurality of nodes 210-1 . . . 8, 211-1 . . . n. Each of these nodes may generate log lines, as described above with respect to FIG. 1. The enclosure may also include chassis managers 220-1 . . . 3. The chassis managers may be coupled to the nodes and act as load aggregation nodes. For example, chassis manager 220-1 may act as the load aggregation node for nodes 210-1 . . . 8, Chassis manager 220-2 may act as the load aggregation node for nodes 211-1 . . . n. In some example implementations, a chassis manager may be associated with at least eight nodes. It should be understood that a node may typically be associated with a single chassis manager for purposes of logging lines to a log server.

The chassis manager may contain a processor 221 and a non-transitory processor readable medium 222 containing a set of instructions thereon, which when executed by the processor cause the processor to implement the techniques described herein. For example, the medium may include log line receive/append instructions 223, log line secure forward instructions 224, and log node broadcast/respond instructions 225.

In operation, just as above, the chassis managers may notify the nodes that they have log aggregation capabilities. For example, the log node broadcast/respond instructions 225 may be used to allow the chassis manager and the nodes to identify each other. As explained above, this may be through a broadcast mechanism wherein the chassis manager broadcasts its log aggregation capabilities, or it may be in a request-response mechanism, wherein the chassis manager responds to a request for log aggregation node identification. Regardless of implementation, each node may be able to identify the chassis manager to which log lines are to be sent. Again, as above, each node may establish a connection with the identified chassis manager.

As shown in FIG. 2, chassis manager may be the log aggregation node for nodes 210-1 . . . 8, while chassis manager 220-2 may be the log aggregation node for nodes 211-1 . . . n, Each of these chassis managers may receive log lines from their respective nodes. For example, chassis managers 220-1,2 may use log line receive / append instructions 223 to receive log lines from the nodes 210, 211. The chassis managers 220-1,2 may then append node identifiers, as described above, to each log line. However, instead of forwarding the log lines to a log server directly, chassis managers 220-1,2 may forward log lines to chassis manager 220-3.

Chassis manager 220-3 may receive log lines forwarded from chassis managers 220-1,2. Chassis manager 220-3 may then use log line secure forward instructions 224 to establish a secure connection to log server 240. Chassis manager 220-3 may then forward the log lines received from chassis manager 220-1,2 to the log server. It should be noted that chassis manager 220-3 does not receive any log lines directly from and of nodes 210-1. . . 8, or 211-1 . . . n. Rather, chassis manager receives log lines indirectly through other chassis managers.

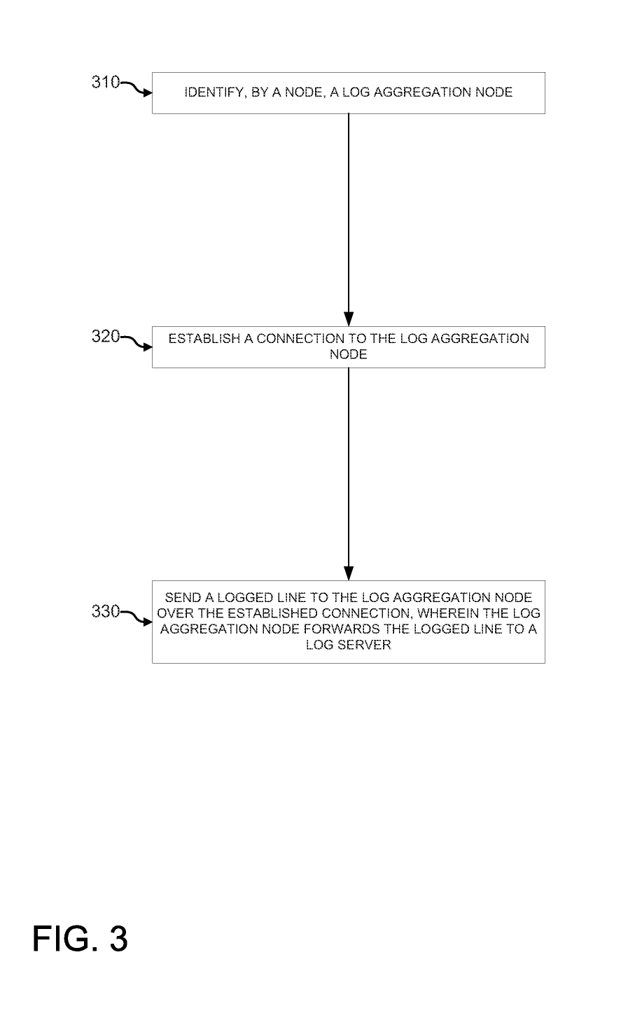

FIG. 3 is an example of a high level flow diagram for forwarding log lines to a log aggregation node, according to the techniques described herein. In block 310, a node may identify a log aggregation node. As explained above, the log aggregation node may receive log lines from a plurality of nodes. In block 320, a connection to the log aggregation node may be established. In some example implementations, this connection may be within a trusted domain, such that the connection need not be secure. Thus, no encryption may be needed on the connection between the node and the log aggregation node.

In block 330, a logged line may be sent to the log aggregation node over the established connection. Logged lines may be received from any number of different nodes over any number of established connections. The log aggregation node may then forward the logged line to a log server. As explained above, the log line may have a node identifier appended to it and the connection to the log server may be a secure connection, such as a connection provided by SSH.

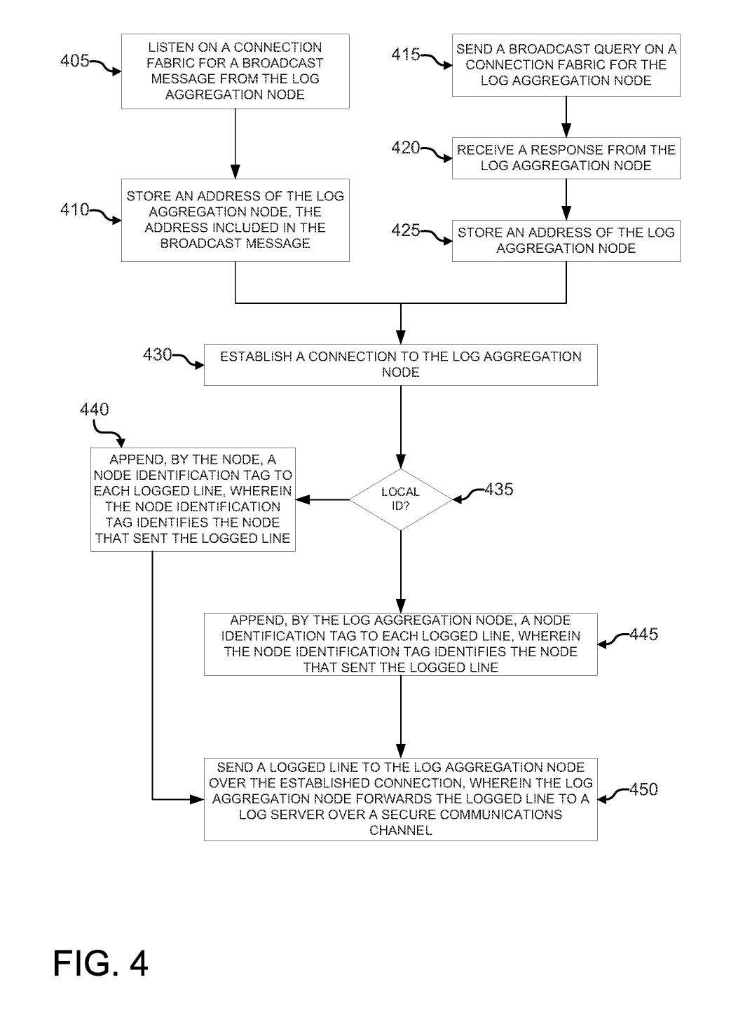

FIG. 4 is an example of a high level flow diagram for identifying a log aggregation node and forwarding log lines to the identified node according to techniques described herein, In one example implementation, the process starts in block 405. In block 405, a node may listen on a connection fabric for a broadcast message from the log aggregation node. As explained above, in some example implementations, a log aggregation node may broadcast its presence on a connection fabric for all other nodes to receive. In block 410, the address of the log aggregation node may be stored, the address having been included in the broadcast message received in block 405.

In another example implementation, the process starts in block 415. In block 415, a node may send a broadcast query on a connection fabric for the log aggregation node. In other words, the node may request the log aggregation node to identify itself. In block 420, a response from the log aggregation node may be received. In block 425, the address of the log aggregation node may be stored.

In either example implementation, the process moves to block 430, in which a connection to the log aggregation node may be established. As explained above, in some example implementations, the connection need not be a secure connection, as the nodes and the log aggregation node may both be within a trusted domain, However, the techniques described herein are applicable even when the connection between the node and the log aggregation node is a secure connection.

In block 435, it may be determined if the node identifier is to be appended by the sending node (e.g. local node) or by the log aggregation node. If the node identifier is to be appended by the sending node, the process moves to block 440. In block 440, the node may append a node identification tag to each logged line. The node identification tag may be used to identify the node that sent the logged line. If the node identifier is to be appended by the log aggregation node, the process moves to block 445. In block 445, the log aggregation node may append a node identification tag to each logged line. The node identification tag may identify the node that sent the logged line.

Regardless of which node appends the node identification tag, the process moves to block 450. In block 450, the logged line may be sent to the log aggregation node over the established connection. The log aggregation node may forward the logged line to a log server over a secure communications channel.

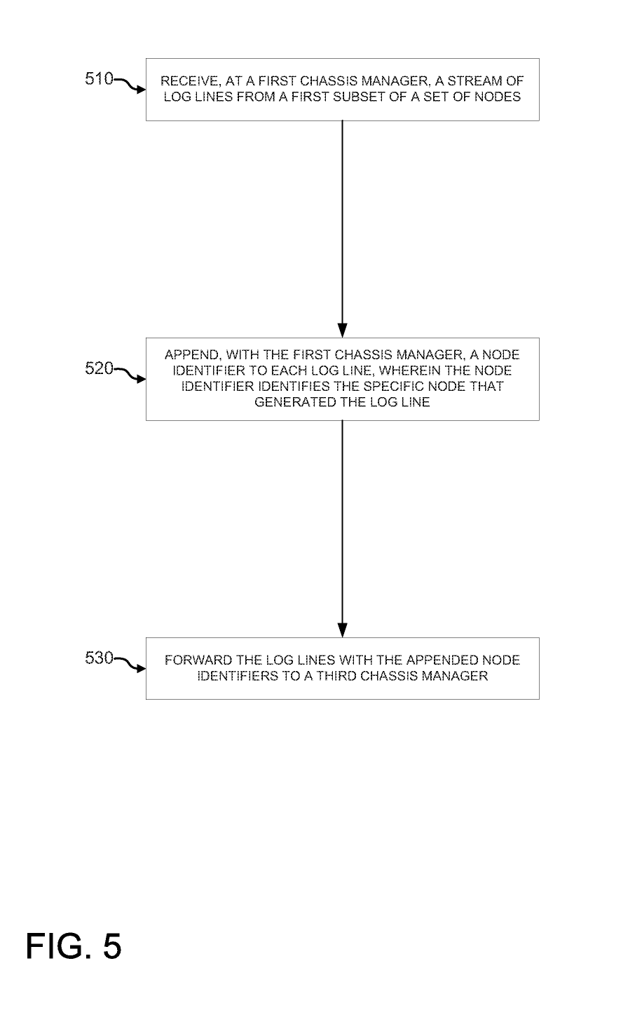

FIG. 5 is an example of a high level flow diagram for receiving log lines from nodes and appending node identifiers prior to forwarding, in accordance with techniques described herein. In block 510, a first chassis manager may receive a stream of log lines form a first subset of a set of nodes. As explained above, a chassis manager may be responsible for many different nodes. Each node may be sending log lines, as a stream, to its designated chassis manager. Thus, the chassis manager may be receiving log lines from many different nodes that have been assigned to the chassis manager.

In block 520, the first chassis manager may append to each log line a node identifier, wherein the node identifier identifies the specific node that generated the log line. As explained above, the node identifier may be used when analyzing log files on a log server to determine from which node a log line was sent. In block 530, the log lines with the appended node identifiers may be forwarded to a third chassis manager. As explained above, in some example implementations, some chassis managers may be responsible for communicating with nodes, such as the first chassis manager described herein. Other chassis managers, such as the third chassis manager, may communicate with the chassis managers responsible for communicating with the nodes, but do not communicate with the nodes themselves.

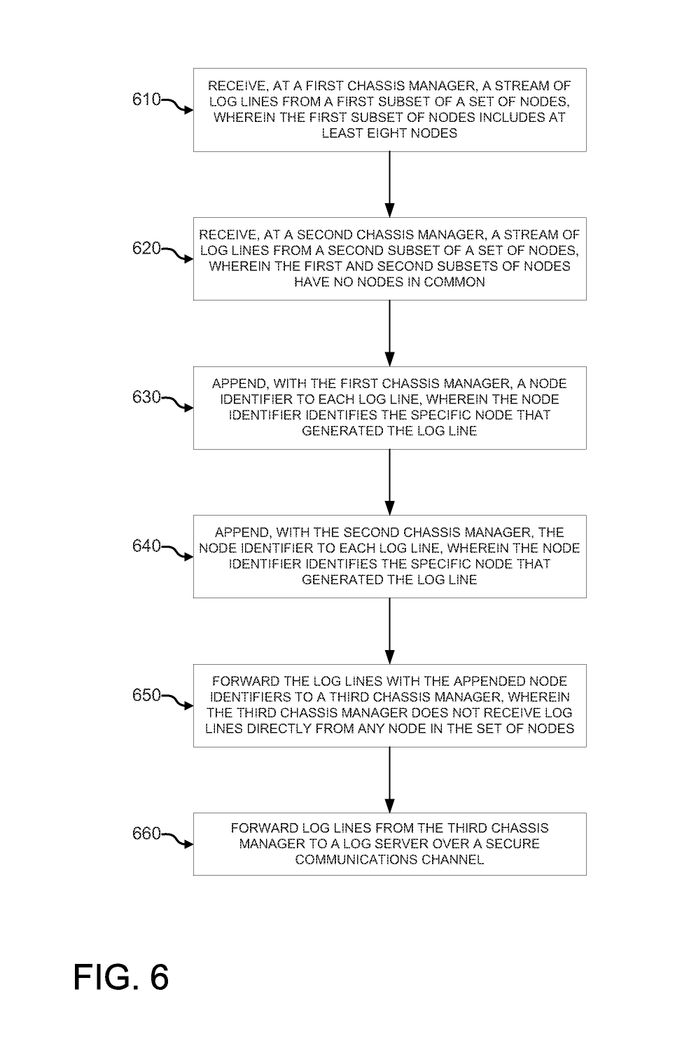

FIG. 6 is another example of a high level flow diagram for forwarding log lines to a node that aggregates log lines from other log aggregation nodes, according to techniques described herein. In block 610, just as above, a first chassis manager may receive a stream of log lines from a first subset of a set of nodes. In an example implementation, the first subset of nodes includes at least eight nodes. In block 620, a second chassis manager may similarly receive log lines from a second subset of nodes. The first and second subset of nodes may have no nodes in common. In other words, each node may communicate with one chassis manager.

In block 630, the first chassis manager may append a node identifier to each log line, wherein the node identifier identifies the specific node that generated the log line. In block 640, the second chassis manager may similarly append the node identifier to each log line. Again, the node identifier may identify which node generated the log line.

In block 650, the log lines may be forwarded form the first and second chassis managers to a third chassis manager. The third chassis manager may not receive log lines directly from any node in the set of nodes. In other words, the third chassis manager receives log lines forwarded from other chassis managers, not from nodes themselves. IN block 660, the third chassis manager may forward the log lines to a log server over a secure communications channel.

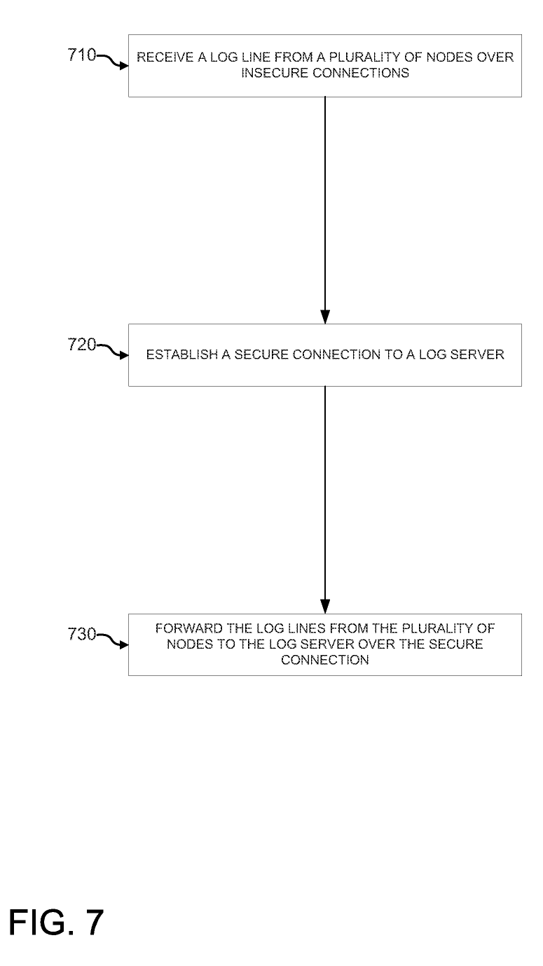

FIG. 7 is an example of processor instructions for receiving log lines from nodes and forwarding to a log server according to techniques described herein. In block 710, the instructions may cause the processor to receive a log line form a plurality of nodes over insecure connections. As explained above, in some example implementations, nodes sending log lines and aggregation nodes are contained within the same trusted domain. Thus, communications between the node and a log aggregation node need not be over a secure communications channel.

In block 720, the instructions may cause the processor to establish a secure connection to a log server. As explained previously, the log server may not be in a trusted domain, and as such the connection to the log server may be a secure connection. However, because the connection is from the log aggregation node, instead of each node individually, a reduced number of secure connections may be needed. Thus the overhead of establishing and maintaining a secure connection is reduced. IN block 730, the instructions may cause the processor to forward the log lines from the plurality of nodes to the log server over the secure connection.

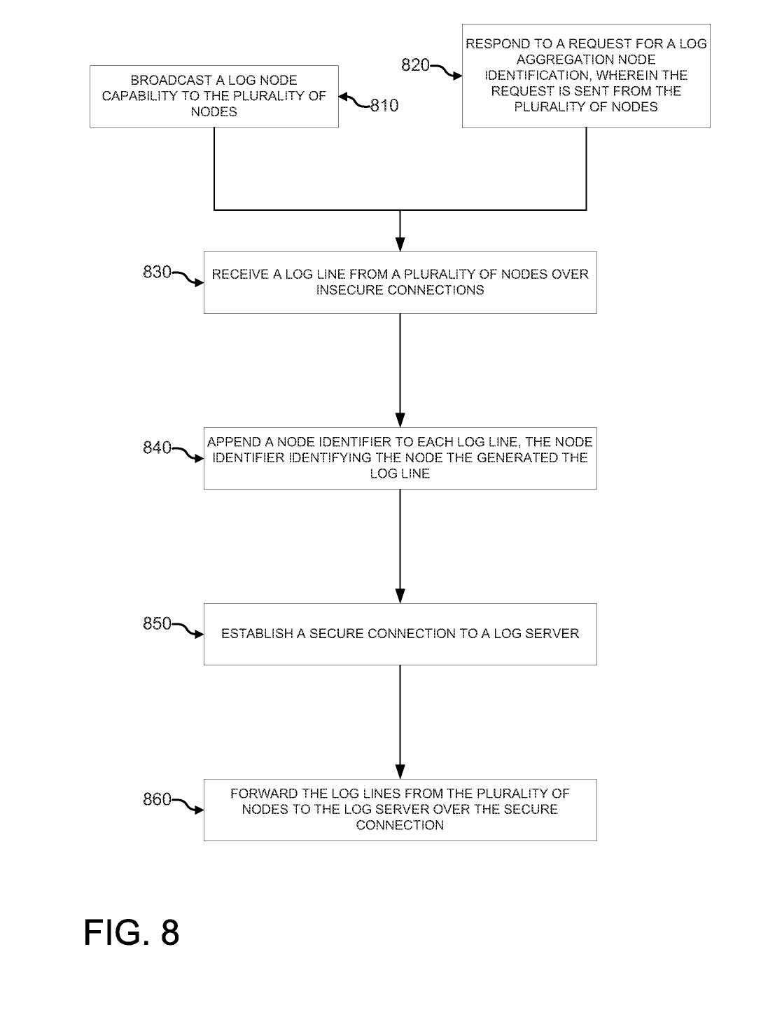

FIG. 8 is an example of processor instructions for identifying a log aggregation node as well as forwarding to a log server according to techniques described herein. In one example implementation, in block 810, the instructions may cause the processor to broadcast a log node capability to the plurality of nodes, In other words, the log aggregation node may broadcast to all other nodes that it has the capability to act as a log aggregation node, In an alternate example implementation, in block 820, a log aggregation node may respond to a request for log aggregation node identification, wherein the request is sent from the plurality of nodes. In other words, the plurality of nodes may request the log aggregation node to identify itself, and the log aggregation node responds, indicating to the request.

In either implementation, in block 830, the instructions may cause the processor to receive a log line from a plurality of nodes over insecure connections. As has been explained above, the nodes and the aggregation node may be in a trusted domain, such that use of insecure communications channels is acceptable. In block 840, the instructions may cause the processor to append a node identifier to each log line. The node identifier may identify the node that generated the log line.

In block 850, a secure connection to a log server may be established, As explained above, the log server and the log aggregation node may not be in the same trusted domain. As such, to ensure secure communications, a secure connection may be established between the log aggregation node and the log server. In block 860, the instructions may cause the processor to forward the log lines form the plurality of nodes to the log server over the secure connection.

We claim:

1. A method comprising:
identifying, by a node, a log aggregation node;
establishing a connection to the log aggregation node; and
sending a logged line to the log aggregation node over the established connection, wherein the log aggregation node forwards the logged line to a log server.

2. The method of claim 1 wherein identifying the log aggregation node comprises:
listening on a connection fabric for a broadcast message from the log aggregation node; and
storing an address of the log aggregation node, the address included in the broadcast message.

3. The method of claim 1 wherein identifying the log aggregation node comprises:
sending a broadcast query on a connection fabric for the log aggregation node;
receiving a response from the log aggregation node; and
storing an address of the log aggregation node.

4. The method of claim 1 further comprising:
appending, by the node, a node identification tag to each logged line, wherein the node identification tag identifies the node that sent the logged line.

5. The method of claim 1 further comprising:
appending, by the log aggregation node, a node identification tag to each logged line, wherein the node identification tag identifies the node that sent the logged line.

6. The method of claim 1 wherein forwarding of logged lines to the log server is over a secure communications channel.

7. A method comprising:
receiving, at a first chassis manager, a stream of log lines from a first subset of a set of nodes;
appending, with the first chassis manager, a node identifier to each log line, wherein the node identifier identifies the specific node that generated the log line; and
forwarding the log lines with the appended node identifiers to a third chassis manager.

8. The method of claim 7 further comprising:
forwarding log lines from the third chassis manager to a log server over a secure communications channel.

9. The method of claim 7 wherein the third chassis manager does not receive log lines directly from any node in the set of nodes.

10. The method of claim 7 further comprising:
receiving, at a second chassis manager, a stream of log lines from a second subset of a set of nodes;
appending, with the second chassis manager, the node identifier to each log line, wherein the node identifier identifies the specific node that generated the log line; and
forwarding the log lines with the appended node identifiers to the third chassis manager;
wherein the first and second subsets of nodes have no nodes in common.

11. The method of claim 7 wherein the first subset of nodes includes at least eight nodes.

12. A non-transitory processor readable medium containing thereon a set of instructions which when executed by the processor cause the processor to:
receive a log line from a plurality of nodes over insecure connections;
establish a secure connection to a log server; and
forward the log lines from the plurality of nodes to the log server over the secure connection.

13. The medium of claim 12 further comprising instructions to:
append a node identifier to each log line, the node identifier identifying the node that generated the log line.

14. The medium of claim 12 further comprising instructions to:
respond to a request for a log aggregation node identification, wherein the request is sent from the plurality of nodes.

15. The medium of claim 12 further comprising instructions to:
broadcast a log node capability to the plurality of nodes.
